(19) United States
(12) Patent Application Publication
(10) Pub. No.: US 2026/0200150 A1
(43) Pub. Date: Jul. 16, 2026

(54) PLASTICIZING DEVICE, INJECTION MOLDING DEVICE, AND DECELERATOR

(71) Applicant: SEIKO EPSON CORPORATION, Tokyo (JP)

(72) Inventor: Daichi MIYASHITA, MATSUMOTO-SHI, NAGANO-KEN (JP)

(73) Assignee: SEIKO EPSON CORPORATION, Tokyo (JP)

(21) Appl. No.: 19/446,974

(22) Filed: Jan. 13, 2026

(30) Foreign Application Priority Data
Jan. 14, 2025 (JP) 2025-004613

(51) Int. Cl. B29C 45/50

(52) U.S. Cl. CPC B29C 45/5008; B29C 2045/5024

(57) ABSTRACT

A plasticizing device for plasticizing material that includes a drive motor having a rotating drive shaft member; a decelerator configured to reduce speed of rotation of the drive motor and to output rotation; and a screw having a groove and rotating via the decelerator, wherein the decelerator includes a first bearing section that receives a drive force from the drive shaft member, a first covering section that surrounds an outer periphery of the first bearing section and that contacts and covers the first bearing section, and a first gear that surrounds an outer periphery of the first covering section and that rotates in contact with the first covering section and the first covering section includes a first holding section that holds lubricant.

The present application is based on, and claims priority from JP Application Serial Number 2025-004613 filed January 14, 2025, the disclosure of which is hereby incorporated by reference herein in its entirety.

### BACKGROUND

### 1. Technical Field

The present disclosure relates to a plasticizing device, an injection molding device, and a decelerator.

### 2. Related Art

An injection molding device is known which injects a material plasticized by a plasticizing device toward a cavity of a molding die and cures the material to mold a molded article.

For example, JP-A-2023-157948 describes a plasticizing device including a drive motor with a rotating drive axis, a decelerator that reduces the speed of rotation of the drive motor and that outputs rotation, a screw that rotates via the decelerator, and a barrel in which is formed a communication hole for guiding barrel a plasticization material to flow out to the outside. The decelerator includes a first gear that is disposed to surround the outer periphery of the drive axis and that rotates in contact with the outer periphery of the drive axis, and a second gear that is disposed to surround the outer periphery of the first gear and that rotates in contact with the outer periphery of the first gear. A groove for causing lubricant to flow is formed in at least one of an outer periphery of the drive axis, an outer periphery of the first gear, an inner periphery of the first gear, an outer periphery of the second gear, and an inner periphery of the second gear.

In the plasticizing device as described above, there is a possibility that the gears are worn due to the lubricant flowing out to the outside, and the life of the decelerator is shortened.

### SUMMARY

A plasticizing device according to an aspect of the present disclosure is a plasticizing device for plasticizing material that includes a drive motor having a rotating drive shaft member; a decelerator configured to reduce speed of rotation of the drive motor and to output rotation; and a screw having a groove and rotating via the decelerator, wherein the decelerator includes a first bearing section that receives a drive force from the drive shaft member, a first covering section that surrounds an outer periphery of the first bearing section and that contacts and covers the first bearing section, and a first gear that surrounds an outer periphery of the first covering section and that rotates in contact with the first covering section and the first covering section includes a first holding section that holds lubricant.

An aspect of an injection molding device according to the present disclosure is an injection molding device that includes the plasticizing device; a nozzle that injects the material plasticized by the plasticizing device; and a mold opening and closing device that opens and closes a molding die having a cavity to which the injected material is supplied.

A decelerator according to an aspect of the present disclosure includes a decelerator that reduces and outputs rotation of a drive motor that has a rotating drive shaft member, the decelerator including a bearing section that receives a drive force from the drive shaft member; a covering section that surrounds an outer periphery of the bearing section and that contacts and covers the bearing section; and a gear surrounding an outer periphery of the covering section and rotating in contact with the covering section, wherein the covering section includes a holding section that holds lubricant.

### BRIEF DESCRIPTION OF THE DRAWINGS

FIG. 1 is a side view schematically illustrating an injection molding device according to the present embodiment.

FIG. 2 is a cross-sectional view schematically illustrating an injection molding device according to the present embodiment.

FIG. 3 is a perspective view schematically illustrating a flat screw of the injection molding device according to the present embodiment.

FIG. 4 is a view schematically illustrating a barrel of the injection molding device according to the present embodiment.

FIG. 5 is a cross-sectional view schematically illustrating a plasticizing device of the injection molding device according to the present embodiment.

FIG. 6 is a cross-sectional view schematically illustrating a plasticizing device of the injection molding device according to the present embodiment.

FIG. 7 is an exploded perspective view schematically illustrating a decelerator of the injection molding device according to the present embodiment.

FIG. 8 is a view schematically illustrating a decelerator of the injection molding device according to the present embodiment.

FIG. 9 is a view schematically illustrating a decelerator of the injection molding device according to the present embodiment.

### DESCRIPTION OF EMBODIMENTS

Hereinafter, preferred embodiments of the present disclosure will be described in detail with reference to the drawings. It should be noted that the embodiments described below do not unduly limit the content of the present disclosure described in the appended claims. All of the configurations described below are not necessarily essential constituent elements of the present disclosure.

### 1. Injection molding device

### 1.1 Overall configuration

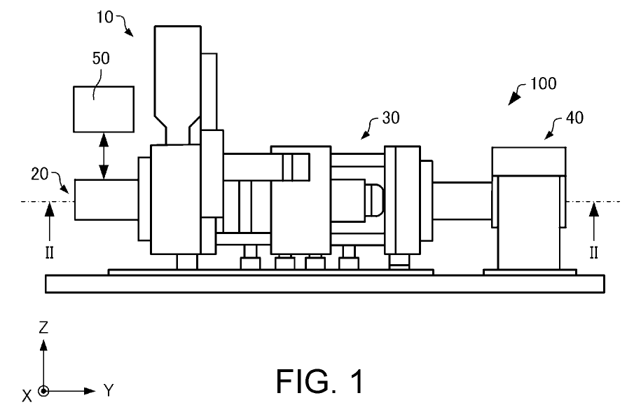

First, an injection molding device according to the present embodiment will be described with reference to the drawings. FIG. 1 is a side view schematically illustrating an injection molding device 100 according to the present embodiment. It should be noted that, in FIG. 1, an X-axis, a Y-axis, and a Z-axis are illustrated as three axes orthogonal to one another. The X-axis direction and the Y-axis direction are, for example, horizontal directions. The Z-axis direction is, for example, a vertical direction.

As illustrated in FIG. 1, the injection molding device 100 includes, for example, a material supply section 10, an injection section 20, a mold section 30, a molding die clamping section 40, and a control section 50.

The material supply section 10 supplies a material that serves as a raw material to the injection section 20. The material supply section 10 may be configured by a hopper. The material supplied from the material supply section 10 has, for example, a pellet form. The material supplied from the material supply section 10 is, for example, acrylonitrile butadiene styrene (ABS) resin.

The injection section 20 plasticizes the material supplied from the material supply section 10 to form a plasticization material. The injection section 20 injects the plasticization material toward the mold section 30.

It should be noted that the term “plasticization" is a concept including melting, and means changing from a solid to a state having fluidity. Specifically, in the case of a material that undergoes glass transition, the plasticization means that the temperature of the material is set to a temperature equal to or higher than the glass transition point. In the case of a material that does not undergo glass transition, plasticization means that the temperature of the material is raised to the melting point or higher.

A cavity corresponding to the shape of the molded article is formed in the mold section 30. The plasticization material injected from the injection section 20 flows into the cavity. The plasticization material is cooled and solidified to produce a molded article.

The molding die clamping section 40 opens and closes the mold section 30. The molding die clamping section 40 opens the mold section 30 after the plasticization material is cooled and solidified. By this, the molded article is discharged to the outside.

The control section 50 is configured by, for example, a computer including a processor, a main storage device, and an input and output interface that inputs and outputs signals to and from the outside. The control section 50 performs various functions by, for example, the processor executing a program read into the main storage device. Specifically, the control section 50 controls the injection section 20 and the molding die clamping section 40. It should be noted that the control section 50 may be configured by a combination of a plurality of circuits instead of a computer.

### 1.2 Specific configuration

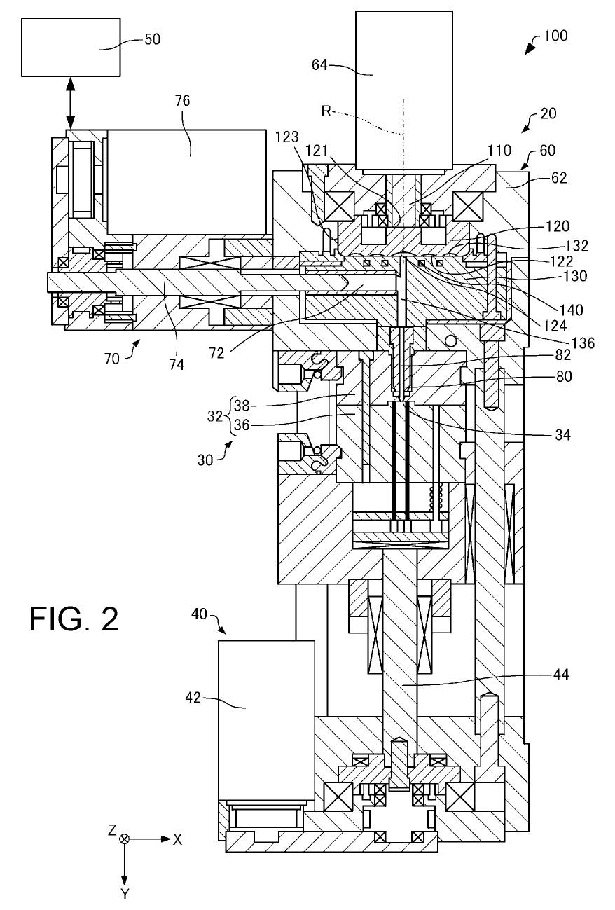

FIG. 2 is a cross-sectional view taken along line II-II of FIG. 1, schematically illustrating the injection molding device 100. As illustrated in FIG. 2, the injection section 20 includes, for example, a plasticizing device 60, an injection mechanism 70, and a nozzle 80.

The plasticizing device 60 is configured to plasticize at least a part of the material supplied from the material supply section 10, generate a pasty plasticization material having fluidity, and guide the plasticization material to the injection mechanism 70. The plasticizing device 60 includes, for example, a screw case 62, a drive motor 64, a decelerator 110, a flat screw 120, a barrel 130, and a heating section 140.

The screw case 62 is a housing that accommodates the flat screw 120. The flat screw 120 is accommodated in a space surrounded by the screw case 62 and the barrel 130.

The drive motor 64 rotates the flat screw 120 via the decelerator 110. The drive motor 64 is controlled by the control section 50. The decelerator 110 reduces the speed of rotation of the drive motor 64 and outputs rotation. The details of the drive motor 64 and the decelerator 110 will be described later. It should be noted that, for convenience, the decelerator 110 is illustrated in a simplified manner in FIG. 2.

The flat screw 120 has a substantially cylindrical shape in which the size in the direction of rotation axis R is smaller than the size in the direction orthogonal to the direction of rotation axis R. In the illustrated example, rotation axis R is parallel to the Y-axis. The flat screw 120 rotates about rotation axis R via the decelerator 110 by the torque generated by the drive motor 64.

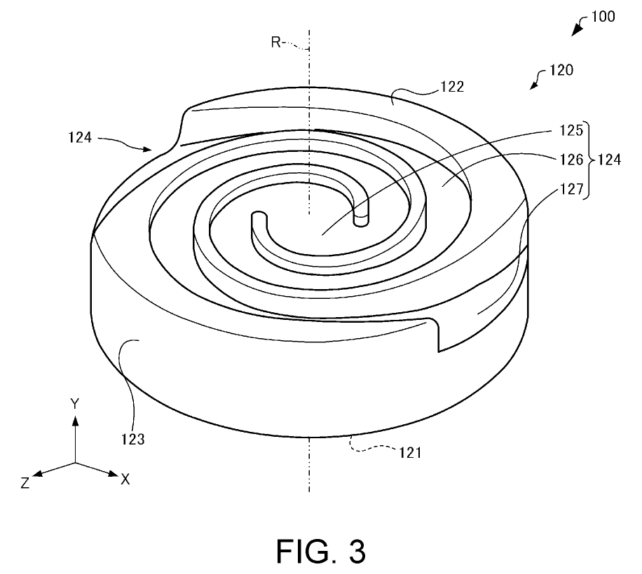

The flat screw 120 has a connection surface 121 connected to the decelerator 110, a groove forming surface 122 on the opposite side to the connection surface 121, and a coupling surface 123 coupling the connection surface 121 and the groove forming surface 122. The groove forming surface 122 has a first groove 124. The coupling surface 123 is, for example, perpendicular to the groove forming surface 122. FIG. 3 is a perspective view schematically illustrating the flat screw 120. It should be noted that, for convenience, FIG. 3 illustrates a state in which the vertical positional relationship is reversed from the state illustrated in FIG. 2.

As illustrated in FIG. 3, a first groove 124 is formed in the groove forming surface 122 of the flat screw 120. The first groove 124 includes, for example, a central section 125, a connecting section 126, and a material inlet section 127. The central section 125 faces a communication hole 136 that is formed in the barrel 130. The central section 125 communicates with the communication hole 136. The connecting section 126 connects the central section 125 and the material inlet section 127. In the illustrated example, the connecting section 126 is formed in a spiral shape from the central section 125 toward the outer periphery of the groove forming surface 122. The material inlet section 127 is formed on the outer periphery of the groove forming surface 122. That is, the material inlet section 127 is formed on the coupling surface 123 of the flat screw 120. The material supplied from the material supply section 10 is introduced from the material inlet section 127 into the first groove 124, passes through the connecting section 126 and the central section 125, and is transported to the communication hole 136 formed in the barrel 130. For example, two first grooves 124 are formed.

It should be noted that the number of first grooves 124 is not particularly limited. Although not illustrated, three or more first grooves 124 may be formed, or only one first groove may be formed.

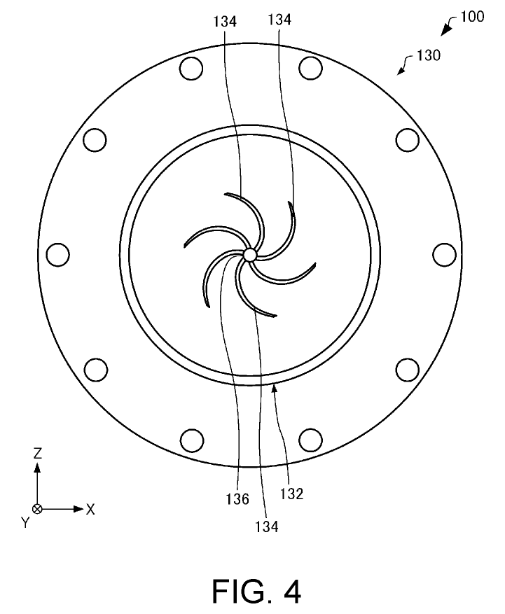

As illustrated in FIG. 2, the barrel 130 is provided below the flat screw 120. The barrel 130 has a facing surface 132 that opposes the groove forming surface 122 of the flat screw 120. The communication hole 136, which communicates with the first groove 124, is formed at the center of the facing surface 132. Here, FIG. 4 is a figure schematically illustrating the barrel 130.

As illustrated in FIG. 4, second grooves 134 and a communication hole 136 are formed in the facing surface 132 of the barrel 130. A plurality of second grooves 134 are formed. In the illustrated example, six second grooves 134 are formed, but the number of second grooves 134 is not particularly limited. The plurality of second grooves 134, when viewed from the Y-axis direction, are formed around the communication hole 136. The second grooves 134 have one end connected to the communication hole 136 and extend in a spiral shape from the communication hole 136 toward the outer periphery of the barrel 130. The second grooves 134 have a function of guiding the plasticization material to the communication hole 136.

It should be noted that the shape of the second grooves 134 is not particularly limited, and may be, for example, a linear shape. The second grooves 134 may not be connected to the communication hole 136 at one end. The second grooves 134 may not be formed in the facing surface 132. However, in consideration of efficiently guiding the plasticized material to the communication hole 136, the second grooves 134 are preferably formed in the facing surface 132.

As illustrated in FIG. 2, the heating section 140 is provided in the barrel 130. The heating section 140 is a heater. The heating section 140 is, for example, a rod heater. The heating section 140 heats the material supplied between the flat screw 120 and the barrel 130. The output of the heating section 140 is controlled by the control section 50. The plasticizing device 60 heats the material while transporting the material toward the communication hole 136 by the flat screw 120, the barrel 130, and the heating section 140, and generates a plasticization material. The plasticizing device 60 causes the generated plasticization material to flow out from the communication hole 136. It should be noted that the shape of the heating section 140, when viewed from the Y-axis direction, may be a ring-shaped. The heating section 140 may not be provided in the barrel 130, and may be provided in the flat screw 120, for example.

The injection mechanism 70 includes, for example, a cylinder 72, a plunger 74, and a plunger drive section 76. The cylinder 72 is a substantially cylindrical member connected to the communication hole 136. The plunger 74 moves inside the cylinder 72. The plunger 74 is driven by a plunger drive section 76 including a motor, a gear, and the like. The plunger drive section 76 is controlled by the control section 50. It should be noted that, although not illustrated, the cylinder 72 may be connected to a flow path downstream of the communication hole 136.

The injection mechanism 70 performs metering and injection operations by the plunger 74 sliding inside the cylinder 72. Metering operation refers to an operation in which the plunger 74 is moved in the -X-axis direction away from the communication hole 136, thereby guiding the plasticization material located in the communication hole 136 into the cylinder 72 and measuring it in the cylinder 72. Injection operation refers to an operation in which the plunger 74 is moved in the +X-axis direction approaching the communication hole 136, thereby injecting the plasticization material in the cylinder 72 into the mold section 30 via the nozzle 80.

The nozzle 80 has a nozzle aperture 82 communicating with the communication hole 136. The nozzle 80 injects the plasticization material plasticized by the plasticizing device 60 into a molding die 32 of the mold section 30. Specifically, by executing the above-described metering operation and injection operation, the plasticization material measured in the cylinder 72 is sent from the injection mechanism 70 to the nozzle aperture 82 via the communication hole 136. The plasticization material is injected from the nozzle aperture 82 into the mold section 30.

The mold section 30 has a molding die 32. The plasticization material injected from the nozzle 80 is supplied to the cavity 34 of the molding die 32. Specifically, the molding die 32 includes a movable molding die 36 and a fixed molding die 38 facing each other, and includes the cavity 34 between the movable molding die 36 and the fixed molding die 38. The cavity 34 is a space corresponding to the shape of the molded article. The movable molding die 36 and the fixed molding die 38 are made of metal. It should be noted that the movable molding die 36 and the fixed molding die 38 may be made of ceramic or resin.

The molding die clamping section 40 includes, for example, a molding die drive section 42 and a ball screw section 44. The molding die drive section 42 is configured by, for example, a motor, a gear, and the like. The molding die drive section 42 is connected to the movable molding die 36 via a ball screw section 44. The molding die drive section 42 is controlled by the control section 50. The ball screw section 44 transmits power generated by drive of the molding die drive section 42 to the movable molding die 36. The molding die clamping section 40 is a mold opening and closing device that opens and closes the mold section 30 by moving the movable molding die 36 by the molding die drive section 42 and the ball screw section 44.

### 1.3. Drive motor decelerator

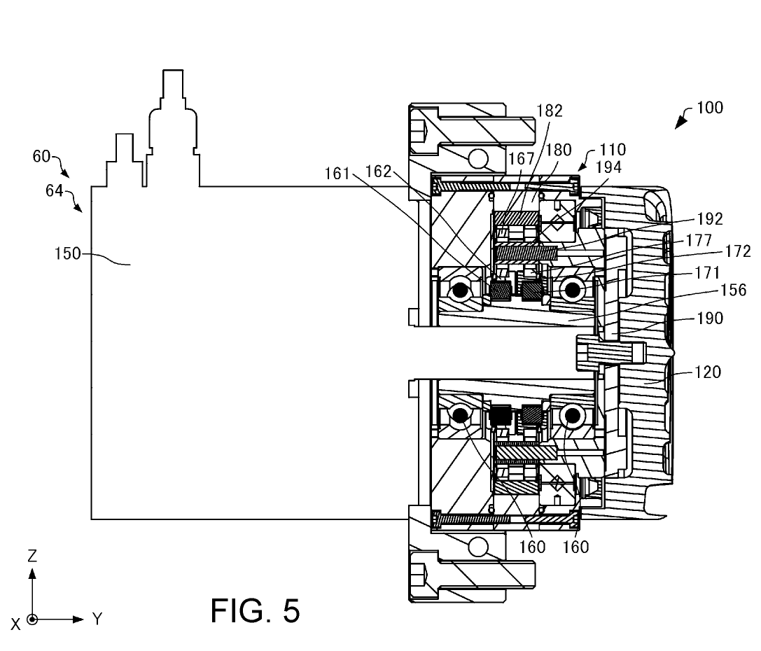

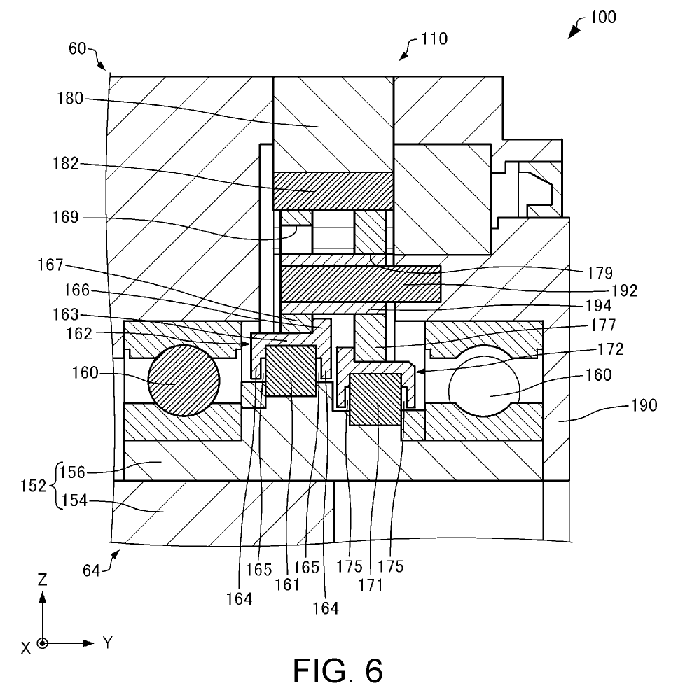

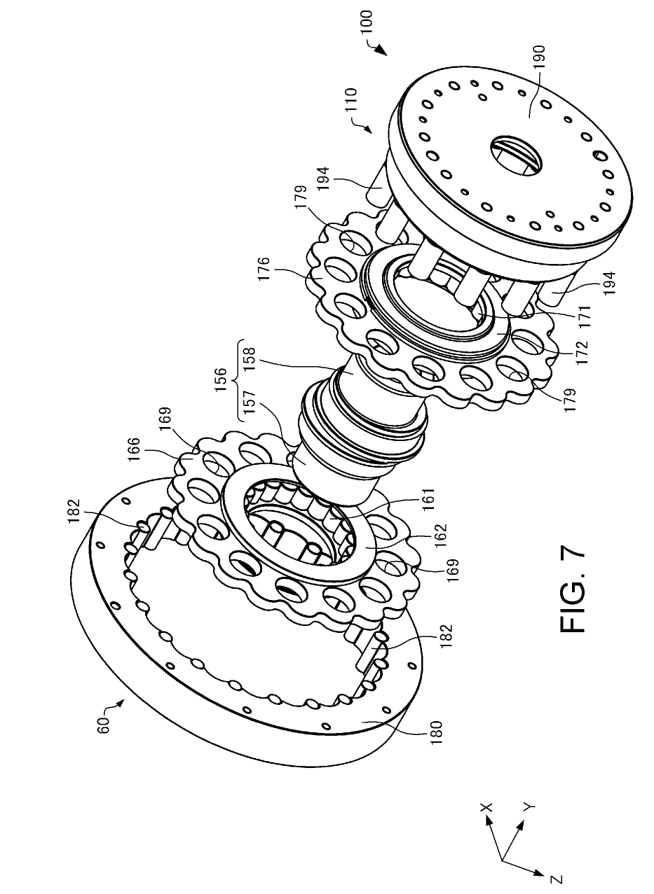

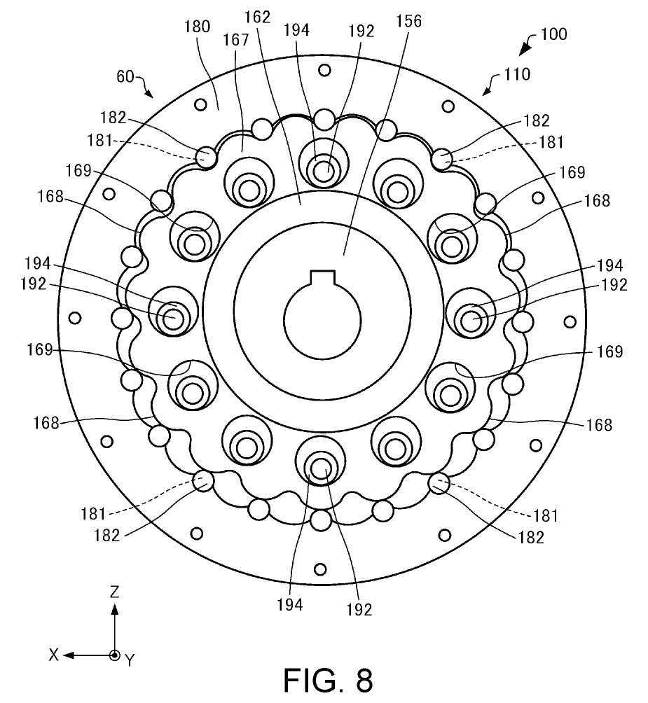

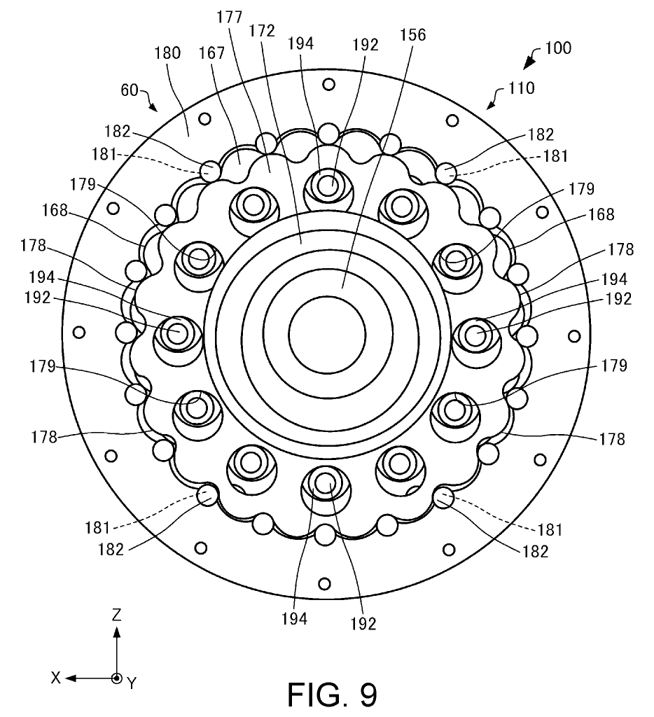

FIGS. 5 and 6 are cross-sectional views schematically illustrating the plasticizing device 60. FIG. 7 is an exploded perspective view schematically illustrating the decelerator 110 of the plasticizing device 60. FIGS. 8 and 9 are figures schematically illustrating the decelerator 110 of the plasticizing device 60. It should be noted that FIG. 6 is an enlarged view of a part of the plasticizing device 60.

As illustrated in FIGS. 5 to 9, the drive motor 64 includes, for example, a main body section 150 that generates a rotational drive force, and a drive shaft member 152 that is rotated by rotational drive force generated by the main body section 150. The main body section 150 includes, for example, a servo motor. The drive shaft member 152 rotates about an axis parallel to the Y-axis, for example. The drive shaft member 152 is constituted by, for example, an output shaft member 154 and a substantially cylindrical eccentric shaft 156 fixed to the periphery of the output shaft member 154.

The eccentric shaft 156 is provided between the main body section 150 and the flat screw 120. The eccentric shaft 156 constitutes the outer periphery of the drive shaft member 152. As illustrated in FIG. 7, the eccentric shaft 156 has, for example, a first eccentric section 157 and a second eccentric section 158. The first eccentric section 157 and the second eccentric section 158 are connected to each other. The eccentric sections 157 and 158 are eccentrically disposed opposite to each other. In the illustrated example, the first eccentric section 157 is located on the -Y-axis direction side of the second eccentric section 158.

The decelerator 110 includes, as illustrated in FIGS. 5 to 9, for example, ball bearings 160, a first bearing section 161, a first covering section 162, a first planetary gear 167, a second bearing section 171, a second covering section 172, a second planetary gear 177, an internal gear 180, needle rollers 182, an output shaft member 190, a pin 192, and a hollow roller 194. The decelerator 110 has a so-called inscribed planetary gear mechanism.

It should be noted that, for the sake of convenience, the ball bearings 160, the second bearing section 171, the second covering section 172, the second planetary gear 177, and the output shaft member 190 are not illustrated in FIG. 8. In FIG. 9, the ball bearings 160 and the output shaft member 190 are not illustrated.

As illustrated in FIG. 6, the ball bearings 160 pivotally supports the eccentric shaft 156. In the illustrated example, two ball bearings 160 are provided. The first bearing section 161 and the second bearing section 171 are provided between the two ball bearings 160.

The first bearing section 161 receives the drive force from the eccentric shaft 156. The first bearing section 161 surrounds the outer periphery of the eccentric shaft 156. The first bearing section 161 is in contact with the first eccentric section 157 of the eccentric shaft 156. The first bearing section 161 rotates with rotation of the eccentric shaft 156. The first bearing section 161 is provided between the eccentric shaft 156 and the first covering section 162. In the illustrated example, the first bearing section 161 is a cylindrical roller. The first bearing section 161 is made of, for example, chromium molybdenum steel (SUSJ2). It should be noted that, although not illustrated, the first bearing section 161 may be a roller bearing, a needle pin, a needle bearing, or the like.

The first covering section 162 surrounds the outer periphery of the first bearing section 161. The first covering section 162 is in contact with the first bearing section 161. The first covering section 162 covers the first bearing section 161. The first covering section 162 has, for example, a substantially annular shape. The first covering section 162 rotates in accordance with rotation of the first bearing section 161. The material of the first covering section 162 is, for example, the same as the material of the first bearing section 161.

As illustrated in FIG. 6, the first covering section 162 includes, for example, a contact section 163 that is in contact with the first bearing section 161, overlapping sections 164 that overlap the first bearing section 161 when viewed in the Y-axis direction, first holding sections 165 that hold lubricant, and a restriction section 166 that restricts movement of the first planetary gear 167 in the Y-axis direction.

The contact section 163 extends in the Y-axis direction. The overlapping sections 164 are connected to the contact section 163. The overlapping sections 164 extend from the contact section 163 toward the eccentric shaft 156. In the example illustrated in FIG. 6, the overlapping sections 164 extend from the contact section 163 in the -Z-axis direction. For example, two overlapping sections 164 are provided. The first bearing section 161 is positioned between the two overlapping sections 164.

The first holding sections 165 are provided between the first bearing section 161 and the overlapping sections 164. The first holding sections 165 are formed by a gap between the first bearing section 161 and the overlapping sections 164. In the illustrated example, two first holding sections 165 are provided. The first bearing section 161 is positioned between the two first holding sections 165. A lubricant is supplied to the first holding sections 165. The lubricant smooths, for example, the movement of the first bearing section 161.

The restriction section 166 is provided between the first planetary gear 167 and the second planetary gear 177. The restriction section 166 extends from the contact section 163 in a direction away from the eccentric shaft 156. In the example illustrated in FIG. 6, the restriction section 166 extends from the contact section 163 in the +Z-axis direction. The restriction section 166 is in contact with, for example, the first planetary gear 167. The restriction section 166 restricts movement of the first planetary gear 167 toward the second planetary gear 177.

The first planetary gear 167 surrounds the outer periphery of the first covering section 162. The first planetary gear 167 is in contact with the first covering section 162. The first planetary gear 167 is provided between the first covering section 162 and the internal gear 180. In the illustrated example, the first planetary gear 167, the first covering section 162, and the first bearing section 161 are arranged in the Z-axis direction. The first planetary gear 167 has, for example, a substantially annular shape. The first planetary gear 167 rotates in accordance with rotation of the first covering section 162. Specifically, the first planetary gear 167 rotates eccentrically inside the internal gear 180. The material of the first planetary gear 167 is, for example, the same as the material of the first bearing section 161. The first planetary gear 167 has a plurality of external teeth 168. In the example illustrated in FIG. 8, 19 of the external teeth 168 are provided. The plurality of external teeth 168 have a wave-like shape.

The second bearing section 171 receives the drive force from the eccentric shaft 156. The second bearing section 171 is arranged with the first bearing section 161 in the Y-axis direction. In the illustrated example, the second bearing section 171 is located on the +Y-axis direction side of the first bearing section 161. The second bearing section 171 is in contact with the second eccentric section 158 of the eccentric shaft 156. The second bearing section 171 rotates with rotation of the eccentric shaft 156. The shape of the second bearing section 171 is, for example, the same as the shape of the first bearing section 161. The material of the second bearing section 171 section is, for example, the same as the material of the first bearing section 161.

The second covering section 172 surrounds the outer periphery of the second bearing section 171. The second covering section 172 is in contact with the second bearing section 171. The second covering section 172 covers the second bearing section 171. The second covering section 172 rotates with rotation of the second bearing section 171. The shape of the second covering section 172 is, for example, the same as the shape of the first covering section 162. Similarly to the first covering section 162, the second covering section 172 includes, for example, a contact section that is in contact with the second bearing section 171, an overlapping section that overlaps the second bearing section 171 when viewed from the Y-axis direction, second holding sections 175 that hold lubricant, and a restriction section that restricts movement of the second planetary gear 177 in the Y-axis direction. The second covering section 172 includes, for example, a circlip. The material of the second covering section 172 is, for example, the same as the material of the first covering section 162.

The second planetary gear 177 surrounds the outer periphery of the second covering section 172. The second planetary gear 177 is in contact with the second covering section 172. In the illustrated example, the second planetary gear 177, the second covering section 172, and the second bearing section 171 are arranged in the Z-axis direction. The second planetary gear 177 rotates with rotation of the second covering section 172. The shape of the second planetary gear 177 is, for example, the same as the shape of the first planetary gear 167. The material of the second planetary gear 177 is, for example, the same as the material of the first planetary gear 167. The first planetary gear 167 and the second planetary gear 177 can equalize the load applied to the eccentric shaft 156. This reduces vibration and noise caused by the decelerator 110.

The internal gear 180 surrounds the outer periphery of the first planetary gear 167 and the second planetary gear 177. The internal gear 180 is configured as a sun inner gear. The internal gear 180 has, for example, a substantially annular shape. The internal gear 180 has a plurality of internal teeth 181. The number of the internal teeth 181 of the internal gear 180 is greater than the number of the external teeth 168 of the first planetary gear 167. In the illustrated example, 20 of the internal teeth 181 are provided. The plurality of internal teeth 181 have a wave-like shape. The internal gear 180 reduces the rotation speed of the first planetary gear 167 based on the difference between the number of the external teeth 168 of the first planetary gear 167 and the number of the internal teeth 181 of the internal gear 180. Similarly, the internal gear 180 decelerates the rotation of the second planetary gear 177 based on the difference between the number of the external teeth 178 of the second planetary gear 177 and the number of the internal teeth 181 of the internal gear 180.

The needle rollers 182 are provided on the internal teeth 181 of the internal gear 180. A plurality of needle rollers 182 are provided corresponding to the plurality of internal teeth 181. The needle rollers 182 are in contact with the planetary gears 167 and 177. The needle rollers 182 have, for example, a columnar shape. The needle rollers 182 rotate with rotation of the planetary gears 167 and 177. This reduces the resistance force against rotation of the planetary gears 167 and 177.

The output shaft member 190 is in contact with the flat screw 120. The output shaft member 190 is provided between the flat screw 120 and the second planetary gear 177. The output shaft member 190 has, for example, a substantially disc shape. The output shaft member 190 outputs rotation of the planetary gears 167 and 177 reduced by the internal gear 180 to the flat screw 120.

The pin 192 extends from the output shaft member 190. In the illustrated example, the pin 192 extends from the output shaft member 190 in the -Y-axis direction. The pin 192 has, for example, a columnar shape. A plurality of pins 192 are provided. In the illustrated example, twelve of the pins 192 are provided. The pin 192 passes through a through hole 169 formed in the first planetary gear 167 and a through hole 179 formed in the second planetary gear 177. When viewed from the Y-axis direction, the shape of the through holes 169 and 179 are, for example, circular shapes. It should be noted that the pin 192 may be provided integrally with the output shaft member 190.

The hollow roller 194 covers the pin 192. The hollow roller 194 has, for example, a cylindrical shape. The hollow roller 194 is inserted into the pin 192. The hollow roller 194 is in contact with the first planetary gear 167 at the through hole 169. The hollow roller 194 is in contact with the second planetary gear 177 at the through hole 179. The hollow roller 194 rotates with rotation of the planetary gears 167 and 177. This reduces the resistance force against rotation of the planetary gears 167 and 177.

The operation of the decelerator 110 will be described. When the drive motor 64 rotates, the eccentric shaft 156 fixed to the output shaft member 154 of the drive motor 64 rotates. The drive force of the eccentric shaft 156 is transmitted to the planetary gears 167 and 177 via the bearing sections 161 and 171 and the covering sections 162 and 172, and the planetary gears 167 and 177 rotates eccentrically inside the internal gear 180. The needle rollers 182 rotate on their axes by rotation of the planetary gears 167 and 177. On the other hand, the internal gear 180 does not rotate. The rotation of the planetary gears 167 and 177 is decelerated by the difference between the external teeth 168 and 178 of the planetary gears 167 and 177 and the internal teeth 181 of the internal gear 180. The rotation of the planetary gears 167 and 177 whose speed has been reduced is transmitted to the output shaft member 190 via the hollow roller 194 and the pin 192, and the output shaft member 190 outputs rotation of the planetary gears 167 and 177 whose speed has been reduced to the flat screw 120. As a result, the flat screw 120 rotates. As described above, the decelerator 110 can reduce the speed of rotation of the drive motor 64 and output rotation to the flat screw 120.

### 1.4 Operational effects

The plasticizing device 60 includes the drive motor 64 that has the rotating drive shaft member 152, the decelerator 110 that reduces the speed of rotation of the drive motor 64 and outputs rotation, and the flat screw 120 that has the first groove 124 formed therein and that rotates via the decelerator 110. The decelerator 110 includes the first bearing section 161 that receives a drive force from the drive shaft member 152, the first covering section 162 that surrounds the outer periphery of the first bearing section 161 and that contacts and covers the first bearing section 161, and the first planetary gear 167 as a first gear that surrounds the outer periphery of the first covering section 162 and that rotates in contact with the first covering section 162. The first covering section 162 includes the first holding sections 165 that hold lubricant.

Therefore, in the plasticizing device 60, the first holding sections 165 are configured to reduce the possibility that the lubricant flows out to the outside. This reduces wear between the first bearing section 161 and the first planetary gear 167 and extends the life of the decelerator 110. The first covering section 162 alone can be replaced, and thus it is possible to easily achieve a long life and a cost reduction of the decelerator 110.

In the plasticizing device 60, the decelerator 110 includes the internal gear 180 as the second gear that surrounds the outer periphery of the first planetary gear 167 and that reduces rotation of the first planetary gear 167, and the output shaft member 190 that outputs the reduced rotation of the first planetary gear 167. Therefore, in the plasticizing device 60, rotation of the first planetary gear 167 whose speed is reduced can be output from the output shaft member 190 to the flat screw 120.

In the plasticizing device 60, the first covering section 162 includes the contact section 163 that is in contact with the first bearing section 161 and that extends in the direction of rotation axis R of the flat screw 120, and the overlapping sections 164 that, when viewed from the direction of rotation axis R, is connected to the contact section 163 and that overlaps the first bearing section 161. The first holding sections 165 are provided between the first bearing section 161 and the overlapping sections 164. Therefore, in the plasticizing device 60, since the load of the first planetary gear 167 can be received by the contact section 163, the load applied to the drive shaft member 152, the first bearing section 161, and the first covering section 162 can be reduced. This makes it possible to increase the life of the decelerator 110.

In the plasticizing device 60, the decelerator 110 includes the second bearing section 171 that is arranged with the first bearing section 161 in the direction of rotation axis R of the flat screw 120 and that receives the drive force from the drive shaft member 152, the second covering section 172 that surrounds the outer periphery of the second bearing section 171 and that contacts and covers the second bearing section 171, and the second planetary gear 177 as the third gear that surrounds the outer periphery of the second covering section 172 and that rotates in contact with the second covering section 172, and the second covering section 172 includes the second holding sections 175 that hold the lubricant. Therefore, in the plasticizing device 60, it is possible to reduce wear between the second bearing section 171 and the second planetary gear 177, and to achieve a long life of the decelerator 110. The second covering section 172 alone can be replaced, and thus it is possible to easily achieve a long life and a cost reduction of the decelerator 110.

In the plasticizing device 60, the first covering section 162 includes the restriction section 166 that is positioned between the first planetary gear 167 and the second planetary gear 177 and that restricts the movement of the first planetary gear 167 in the direction of rotation axis R. Therefore, in the plasticizing device 60, it is possible to suppress interference between the first planetary gear 167 and the second planetary gear 177. This reduces the possibility of damage to the planetary gears 167 and 177, and extends the life of the decelerator 110.

In the plasticizing device 60, the material of the first bearing section 161, the material of the first covering section 162, and the material of the first planetary gear 167 are the same as each other. Therefore, in the plasticizing device 60, it is possible to reduce wear due to a hardness difference between the first bearing section 161 and the first covering section 162 and wear due to a hardness difference between the first covering section 162 and the first planetary gear 167. This makes it possible to increase the life of the decelerator 110.

### 2. Modifications of injection molding device

Next, an injection molding device according to a modification of the present embodiment will be described. Hereinafter, in the injection molding device according to the modification of the present embodiment, points different from the example of the injection molding device 100 according to the present embodiment described above will be described, and the description of the same points will be omitted.

In the injection molding device 100 described above, the material supplied from the material supply section 10 to the injection section 20 is an ABS resin.

In contrast, in the injection molding device according to the modification of the present embodiment, the material supplied from the material supply section 10 to the injection section 20 is a material other than an ABS resin or a material obtained by adding another component to an ABS resin.

Examples of the material supplied from the material supply section 10 include materials that contain various materials as a main material, such as a thermoplastic material, a metal material, and a ceramic material. Here, "main material" means the central material for molding the shape of the molded article formed by the injection molding device, and means a material that occupies a content rate of 50% or more in the molded article. The above-described materials include those obtained by melting the main materials alone, and those obtained by melting some components contained together with the main materials to form a paste.

As a material having thermoplastic material, for example, a thermoplastic resin can be used. Examples of thermoplastic resin include general purpose plastics, general purpose engineering plastics, and super engineering plastics.

Examples of the general purpose plastic include polypropylene (PP), polyethylene (PE), polyvinyl chloride (PVC), and polylactic acid (PLA).

Examples of general purpose engineering plastic include polyacetal (POM), polyamide (PA), polycarbonate (PC), modified polyphenylene ether (m-PPE), polybutylene terephthalate (PBT), and polyethylene terephthalate (PET).

Examples of super engineering plastic include polysulfide (PSU), polyethersulfone (PES), polyphenylene sulfide (PPS), polyarylate (PAR), polyimide (PI), polyamideimide (PAI), polyetherimide (PEI), and polyether ether ketone (PEEK).

The thermoplastic material may contain a pigment, a metal, a ceramic, and additives such as a wax, a flame retardant, an antioxidant, and a heat stabilizer. The material that has thermoplasticity is plasticized and converted into a melting state by rotation of the flat screw 120 and the heating of the heating section 140 in the plasticizing device 60. The plasticization material thus generated is discharged from the nozzle 80, deposited in the cavity 34, and then cured by a decrease in temperature.

In the plasticizing device 60, for example, a metal material may be used as the main material instead of the above-described material that has thermoplasticity. In this case, it is desirable that a component that melts when the plasticization material is generated is mixed with a powder material obtained by powdering the metal material, and the powder material is charged into the plasticizing device 60.

Examples of the metal material include a single metal such as magnesium (Mg), iron (Fe), cobalt (Co), chromium (Cr), aluminum (Al), titanium (Ti), copper (Cu), or nickel (Ni), an alloy that contains one or more of these metals, maraging steel, stainless steel, cobalt chromium molybdenum, a titanium alloy, a nickel alloy, an aluminum alloy, a cobalt alloy, and a cobalt chromium alloy.

In the plasticizing device 60, a ceramic material can be used as the main material instead of the above-described metal material. Examples of a ceramic material include oxide ceramics such as silicon dioxide, titanium dioxide, aluminum oxide, and zirconium oxide, and non-oxide ceramics such as aluminum nitride.

The powder material of the metal material or the ceramic material supplied from the material supply section 10 may be a mixed material obtained by mixing a plurality of types of powders of a single metal, a powder of an alloy, or a powder of a ceramic material. The powder material of the metal material or the ceramic material may be coated with, for example, the above-described thermoplastic resin or another thermoplastic resin. In this case, the thermoplastic resin may be melted in the plasticizing device 60 to exhibit fluidity.

For example, a solvent may be added to the powder material of the metal material or to the ceramic material supplied from the material supply section 10. Examples of the solvent include water; (poly) alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ - picoline, and 2, 6-lutidine; tetraalkylammonium acetates (for example, tetrabutylammonium acetate); and ionic liquids such as butyl carbitol acetate.

In addition, a binder may be added, for example, to the powder material of the metal material or the ceramic material supplied from the material supply section 10. Examples of the binder include an acrylic resin, an epoxy resin, a silicone resin, a cellulose-based resin, other synthetic resins, PLA, PA, PPS, PEEK, and other thermoplastic resins.

The above-described embodiment and modifications are merely examples, and the present disclosure is not limited thereto. For example, the embodiments and the modifications can be combined as appropriate.

The present disclosure includes configurations substantially the same as the configurations described in the embodiments, for example, configurations that have the same functions, methods, and results, or configurations that have the same objects and effects. The present disclosure also includes configurations in which non-essential parts of the configurations described in the embodiments are replaced. The present disclosure includes a configuration that achieves the same operational effects as the configuration described in the embodiment or a configuration that can achieve the same object. The present disclosure also includes configurations in which known techniques are added to the configurations described in the embodiments.

The following contents are derived from the above-described embodiment and modifications.

An aspect of a plasticizing device includes

a plasticizing device for plasticizing material that includes

a drive motor having a rotating drive shaft member;

a decelerator configured to reduce speed of rotation of the drive motor and to output rotation; and

a screw having a groove and rotating via the decelerator,

wherein

the decelerator includes

a first bearing section that receives a drive force from the drive shaft member,

a first covering section that surrounds an outer periphery of the first bearing section and that contacts and covers the first bearing section, and

a first gear that surrounds an outer periphery of the first covering section and that rotates in contact with the first covering section and

the first covering section includes a first holding section that holds lubricant.

According to such a plasticizing device, it is possible to achieve a long life of the decelerator.

One aspect of the plasticizing device may be such that

the decelerator includes

a second gear that surrounds an outer periphery of the first gear and that is configured to decelerate rotation of the first gear and

an output shaft member configured to output rotation of the first gear that was reduced in speed.

According to such a plasticizing device, rotation of the first gear whose speed is reduced can be output from the output shaft member to the screw.

One aspect of the plasticizing device may be such that

the first covering section includes

a contact section that is in contact with the first bearing section and that extends in a rotation axis direction of the screw and

an overlapping section that is connected to the contact section and that, when viewed in the rotation axis direction, overlaps the first bearing section and

the first holding section is provided between the first bearing section and the overlapping section.

According to such a plasticizing device, it is possible to reduce a load applied to the drive shaft member, the first bearing section, and the first covering section.

One aspect of the plasticizing device may be such that

the decelerator includes

a second bearing section that is aligned with the first bearing section in a rotation axis direction of the screw and that receives drive force from the drive shaft member,

a second covering section that surrounds an outer periphery of the second bearing section and that contacts and covers the second bearing section, and

a third gear that surrounds an outer periphery of the second covering section and that rotates in contact with the second covering section and

the second covering section includes second holding sections that hold a lubricant.

According to such a plasticizing device, it is possible to reduce wear between the second bearing section and the second gear.

One aspect of the plasticizing device may be such that

the first covering section includes a restriction section that is positioned between the first gear and the third gear and that restricts movement of the first gear in the rotation axis direction.

According to such a plasticizing device, it is possible to suppress interference between the first gear and the second gear.

One aspect of the plasticizing device may be such that

a material of the first bearing section, a material of the first covering section, and a material of the first gear are the same as each other.

According to such a plasticizing device, it is possible to reduce wear due to a hardness difference between the first bearing section and the first covering section and wear due to a hardness difference between the first covering section and the first gear.

An aspect of an injection molding device includes

an injection molding device that includes

an aspect of the plasticizing device;

a nozzle that injects the material plasticized by the plasticizing device; and

a mold opening and closing device that opens and closes a molding die having a cavity to which the injected material is supplied.

According to such an injection molding device, the life of the decelerator can be extended.

An aspect of the decelerator includes

a decelerator that reduces and outputs rotation of a drive motor that has a rotating drive shaft member, the decelerator including

a bearing section that receives a drive force from the drive shaft member;

a covering section that surrounds an outer periphery of the bearing section and that contacts and covers the bearing section; and

the covering section includes a holding section that holds lubricant.

According to such a decelerator, it is possible to achieve a long life.

What is claimed is:

1. A plasticizing device for plasticizing a material, the plasticizing device comprising:
a drive motor having a rotating drive shaft member;
a decelerator configured to reduce speed of rotation of the drive motor and to output rotation; and
a screw having a groove and rotating via the decelerator, wherein
the decelerator includes:
a first bearing section that receives a drive force from the drive shaft member;
a first covering section that surrounds an outer periphery of the first bearing section and that contacts and covers the first bearing section; and
a first gear that surrounds an outer periphery of the first covering section and that rotates in contact with the first covering section, and
the first covering section includes a first holding section that holds lubricant.

2. The plasticizing device according to claim 1, wherein
the decelerator includes:
a second gear that surrounds an outer periphery of the first gear and that is configured to decelerate rotation of the first gear; and
an output shaft member configured to output rotation of the first gear that was reduced in speed.

3. The plasticizing device according to claim 1, wherein
the first covering section includes:
a contact section that is in contact with the first bearing section and that extends in a rotation axis direction of the screw; and
an overlapping section that is connected to the contact section and that, when viewed in the rotation axis direction, overlaps the first bearing section, and
the first holding section is provided between the first bearing section and the overlapping section.

4. The plasticizing device according to claim 1, wherein
the decelerator includes:
a second bearing section that is aligned with the first bearing section in a rotation axis direction of the screw and that receives the drive force from the drive shaft member;
a second covering section that surrounds an outer periphery of the second bearing section and that contacts and covers the second bearing section; and
a third gear that surrounds an outer periphery of the second covering section and that rotates in contact with the second covering section, and
the second covering section includes a second holding section that holds lubricant.

5. The plasticizing device according to claim 4, wherein
the first covering section includes a restriction section that is positioned between the first gear and the third gear and that restricts movement of the first gear in the rotation axis direction.

6. The plasticizing device according to claim 1, wherein
a material of the first bearing section, a material of the first covering section, and a material of the first gear are the same as each other.

7. An injection molding device comprising:
the plasticizing device according to claim 1;
a nozzle that injects the material plasticized by the plasticizing device; and
a mold opening and closing device that opens and closes a molding die having a cavity to which the injected material is supplied.

8. A decelerator that reduces and outputs rotation of a drive motor that has a rotating drive shaft member, the decelerator comprising:
a bearing section that receives a drive force from the drive shaft member;
a covering section that surrounds an outer periphery of the bearing section and that contacts and covers the bearing section; and
a gear surrounding an outer periphery of the covering section and rotating in contact with the covering section, wherein
the covering section includes a holding section that holds lubricant.
